(19) United States
(12) Patent Application Publication
(10) Pub. No.: US 2009/0045589 A1
(43) Pub. Date: Feb. 19, 2009

(54) Bushing and Lantern Ring for Rotary Fluid Pumping Equipment

(76) Inventors: Christopher S. Patton, Eastern Passage (CA); David W. Valley, Windsor Junction (CA); Arnold T. Lloyd, Elmsdale (CA)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/085,649

(22) PCT Filed: Nov. 28, 2005
(86) PCT No.: PCT/CA2005/001802

§ 371 Date: May 28, 2008

(51) Int. Cl. F16J 15/18

(52) U.S. Cl. 277/516

(57) ABSTRACT

A throat bushing (10, 54) for use in a seal chamber (8) or stuffing box (56) of rotary fluid equipment. The throat bushing defines a first face (13, 60) and a second face (21, 62), an outer surface (11) dimensioned to be received with a tight fit within a throat or bore of the seal chamber (8) or stuffing box (56), and a bore (25) therethrough dimensioned to receive a rotary shaft (3) with clearance to permit free rotation of the rotary shaft (3) therein. The throat bushing comprises at least one tangential channel (22) therethrough leading tangentially from the first face (13, 60) proximal to the outer surface (11), through to the second face (21, 62), proximal to an inner annular surface (12) of the throat bushing bore (25).

### FIELD OF THE INVENTION

This invention relates to improvements in throat bushings commonly employed in the pump housing of centrifugal pumps and other such rotary fluid equipment. The invention further relates to devices which reduce pump flush requirements or extend the amount of time between repairs. More particularly, the invention relates to a throat bushing having at least one channel therethrough to facilitate the evacuation of air and particulate matter trapped in the pump seal chamber or stuffing box, back out towards the volute of the pump housing.

### BACKGROUND OF INVENTION

Throat bushings are well known and commonly employed within the pump housings of centrifugal pumps and other such rotary fluid equipment. They are typically provided to form a restrictive close clearance around the motor shaft or shaft sleeve, in order to separate the impeller in the pump chamber, or volute, from the seal chamber or stuffing/packing box. The throat bushing will be located between the seal and the impeller in the case of mechanical seal applications, or between the impeller and rings of packing, or stuffing, in the case of stuffing box applications.

The main function of the seal chamber/stuffing box is to control the amount of fluid leaking along the motor shaft to the atmosphere. It also prevents air from working along the shaft to the pumping chamber of the pump housing. Frequently the seal chamber/stuffing box will require a source of flush water for cooling and lubricating the seal faces or packing and the motor shaft/shaft sleeve. However, in applications where the fluid being pumped contains abrasives or particulate matter, the requirement for flush supply is much greater. This presents several problems during pump operation. For instance, the flush water supply may become contaminated and require treatment. Additionally, if the pumpage contains a high level of abrasive or particulate matter, large volumes of flush water may be required to increase the lifetime of the mechanical seal or packing and reduce costly repair and pump down-time.

Attempts have been made to address this requirement for flush through modifications to the throat bushing itself. One such example is disclosed in U.S. Pat. No. 5,553,868 (Dunford), which discloses a throat bushing for mechanical seal applications, the bushing having a sloped surface machined into the central bore sloping from the outer cavity wall towards the throat of the seal cavity proximal to the pump shaft. A similar apparatus is disclosed in Canadian Patent Application No. 2,353,708, which discloses a bushing arrangement adaptable for mechanical seal or packing applications. The devices disclosed in U.S. Pat. No. 5,553,868 and Canadian Patent Application No. 2,353,708 are commercially available under the trade-name SpiralTrac™ (EnviroSeal Engineering Products Ltd., Nova Scotia, Canada). However, in order to facilitate the flow of contaminant material out of the seal or packing chamber and obtain maximum benefit, the disclosed devices rely on spiral grooves machined into the sloped surface. The machining of these spiral grooves is difficult, and since centrifugal pumps may rotate in either clockwise or counter-clockwise direction, the hand of the spiral groove must suit the rotation of the equipment to ensure that the fluid and contaminants carried thereby spiral inwardly toward the shaft. In addition, the spiral design of this device only allows for one exit groove which, when blocked, reduces or eliminates the effectiveness of the device.

As another example, U.S. Pat. No. 5,167,418 (Dunford) discloses a grit protector for placement in the seal cavity of rotating fluid processing equipment or adjacent thereto. The device includes an axial portion and a radial flange which, when the device is within the seal cavity, has an inner diameter slightly greater than the pump shaft. The flange has one or more vent passages around its outer circumference. The vents extend into the fluid flow on the seal side, and scoop up a defined volume of fluid as the fluid is rotated by the motion of the shaft, impeller and seal, thereby allowing the rotating fluid from within the seal cavity to be vented outwardly towards the impeller. Contaminant material is thus ejected from the seal cavity to behind the impeller where it is moved radially outward and away from the seal cavity opening. Devices along the lines of that disclosed in U.S. Pat. No. 5,167,418 are known under the trade-name Sealmate™. Such devices, however, are not useful for clearing fibrous material from pump seal chambers, and cannot be used at all in packing applications. In addition, the device can only be manufactured from a limited number of materials, typically stainless steel or hastelloy. The device is generally lacking in structural integrity due to the thinness of material and welding, and is therefore prone to failure under typical conditions of operation. Overall, the device is difficult to manufacture, difficult to install and easily causes shaft damage.

In U.S. Pat. No. 5,718,436 (Dunford), a flow controller/seal protector is disclosed. This device is designed for securement to the rotary shaft within the seal chamber, and protects the shaft and seal from the effects of abrasives and entrained air. The protector has an annular ring member for securing the device to the shaft, and a cylindrical member that extends into the cavity and in close surrounding proximity to the seal. The cylindrical member has an outwardly flared portion at its free open end, as well as flow inducing vanes or vents, to help impart rotational flow to fluid moving within the seal cavity. This rotational fluid flow carries any heavy abrasives trapped near the shaft and seal outwards, through the free open end of the cylindrical member, to then be centrifuged away from the seal and into the main pumpage. Air is centrifuged inwardly towards the back of the seal. Devices along the lines of that disclosed in U.S. Pat. No. 5,718,436 are known under the trade-name Qmax™. This type of device is not considered a throat bushing since it is attached to the shaft of the pump, essentially acting as a sleeve and covering the seal. The device must be screwed in place, and is very limited in use due to restrictions between the seal chamber bore diameter and the outer diameter of the seal. It is specifically designed for open bore pumps, and cannot be used in pumps with a throat.

In an alternate method, a filtering system is disclosed in U.S. Pat. No. 5,372,730 (Warner), whereby a filter screen is used for reducing the amount of particulate matter trapped in the seal chamber or stuffing box.

As can be seen from the above-discussed prior art, the entrapment of particulate matter and air within the pump seal chamber or stuffing box of rotary fluid pumping equipment is a common problem, and there exists a need for air/particulate removal systems which will increase the lifetime of the seal or packing and reduce costly repair and pump down-time. In addition, there is a significant environmental and economic benefit to be realized by reducing the amount of water or fluid needed to flush the seal chamber or stuffing box in such applications.

### SUMMARY OF THE INVENTION

It is therefore an object of the present invention to provide a device that reduces the amount of flush required in pumping applications involving fluid-dispersed particulates, or slurries. It is also an object to provide an effective means of reducing the amount of particulate matter and air that becomes trapped in the pump seal chamber or stuffing box during operation of centrifugal pumps and other such rotary fluid equipment. A further object is to provide a device which allows for more efficient fluid transfer within the seal chamber and reduces heat build up, allowing the seal to operate cooler and for longer periods.

Accordingly, as an aspect of the present invention, there is provided a throat bushing for use in a seal chamber or stuffing box of rotary fluid equipment, the throat bushing defining a first face and a second face, an outer annular surface dimensioned to be received with a tight fit within a throat or bore of the pump seal chamber or stuffing box, and a bore therethrough dimensioned to receive a rotary shaft with clearance to permit free rotation of the rotary shaft therein. The throat bushing comprises at least one tangential channel therethrough, the tangential channel leading tangentially from the first face proximal to the outer annular surface, through to the second face, proximal to an inner annular surface of the throat bushing bore.

As another aspect, the invention provides a lantern ring for use in a stuffing box of rotary fluid equipment, said lantern ring defining a first face and a second face, an outer annular surface dimensioned to be received with a tight fit within the stuffing box, a collection groove formed annularly around the outer annular surface for receiving fluid from a source, and a bore therethrough dimensioned to receive a rotary shaft with clearance to permit free rotation of the rotary shaft therein. The bore tapers outwardly towards the second face starting from a position intermediate between the first face and the second face, and the lantern ring comprises at least one channel leading from an inlet port on the collection groove, to an outlet port on the tapered surface of the lantern ring bore, the channel leading tangentially from the inlet port towards the lantern ring second face.

A kit is also provided as a separate aspect, including both the throat bushing and lantern ring of the present invention adapted for use together in the stuffing box of a centrifugal pump or other such rotary fluid equipment.

There is further provided a device for replacing a typical lantern ring and one or more rings of packing in a stuffing box of a centrifugal pump or other such rotary fluid equipment, the device comprising as a single unitary element the lantern ring and throat bushing defined above, whereby the second face of the lantern ring is connected to the first face of the throat bushing, and the entrance ports and flow modifiers of the throat bushing are positioned on the first face of the throat bushing as close as possible to the outer annular surface thereof without being obstructed by the lantern ring second face.

### BRIEF DESCRIPTION OF DRAWINGS

Embodiments of the present invention will be further described, by way of example, with reference to the accompanying drawings, in which:

FIG. 1 is a schematic illustration of an example of the throat bushing of the present invention, positioned within the throat of the seal chamber of a centrifugal pump;

FIG. 2 illustrates a cross-sectional view of the pump seal chamber and throat bushing shown in FIG. 1;

FIG. 3a illustrates a front plan view of an example of the throat bushing of the present invention, adapted for use within a pump seal chamber;

FIG. 3b illustrates a cross-sectional side view of the throat bushing shown in FIG. 3a;

FIG. 4 is a is a schematic illustration of an example of the throat bushing of the present invention, positioned within the throat of the stuffing box of a centrifugal pump;

FIG. 5 illustrates a cross-sectional view of the stuffing box and throat bushing shown in FIG. 4;

FIG. 6a illustrates a front plan view of an example of the throat bushing of the present invention, adapted for use within a pump stuffing box;

FIG. 6b illustrates a rear plan view of the throat bushing shown in FIG. 6a; and

FIG. 7 is a side sectional view of a lantern ring adaptor for use with the throat bushing of the present invention in centrifugal pump stuffing box arrangements.

### DETAILED DESCRIPTION OF PREFERRED EMBODIMENTS

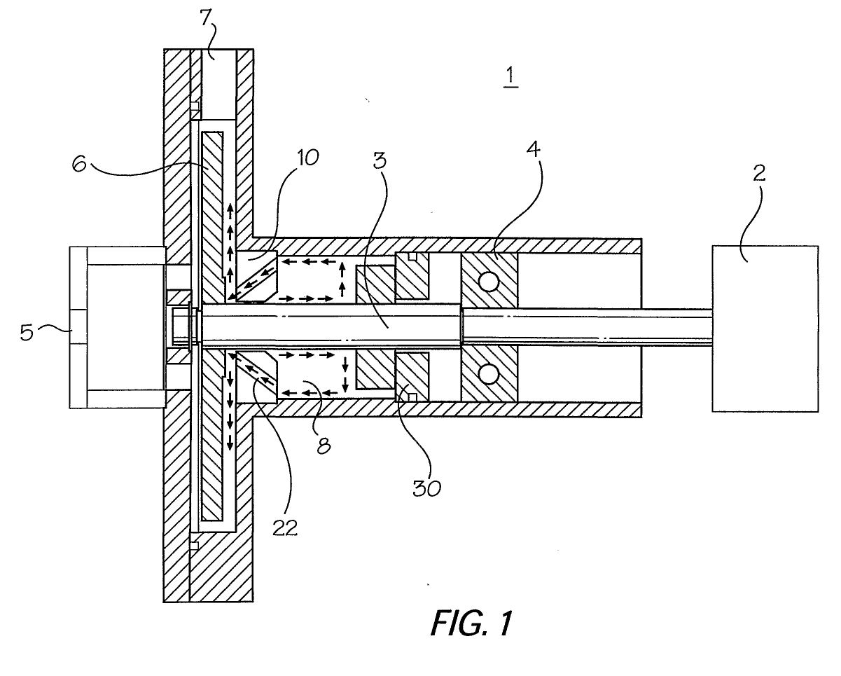

FIG. 1 illustrates one possible operating environment for the throat bushing of the present invention, involving a standard centrifugal pump (1) with a mechanical seal arrangement. As shown, the pump (1) is driven by an electric motor (2), which in turn drives a rotary shaft (3) supported by bearings within a bearing housing (4). The shaft (3) is connected to an impeller (6) at its terminal end. As the impeller (6) is rotated by the shaft, water or other fluid is drawn into the pump housing through an inlet (5), and pumped out to the environment through pump outlet (7).

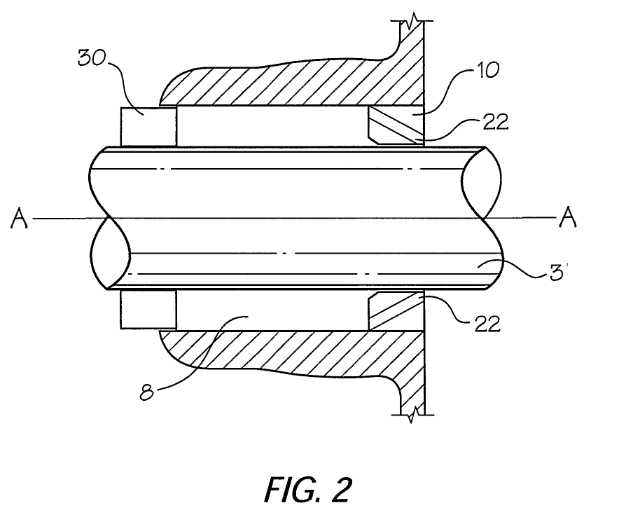

As illustrated in FIG. 1, and in expanded view in FIG. 2, the throat bushing (10) of the present invention is placed in the throat of a seal chamber (8), with the pump shaft (3) running through its bore. The axis of rotation of pump shaft (3) is represented by line A-A shown in FIG. 2. A mechanical seal (30) is positioned at the rear end of the seal chamber (8). Tangential channels (22) bored through the throat bushing (10) provide a passageway for particulate matter to be evacuated from the seal chamber (8) to the pump chamber behind the impeller (6).

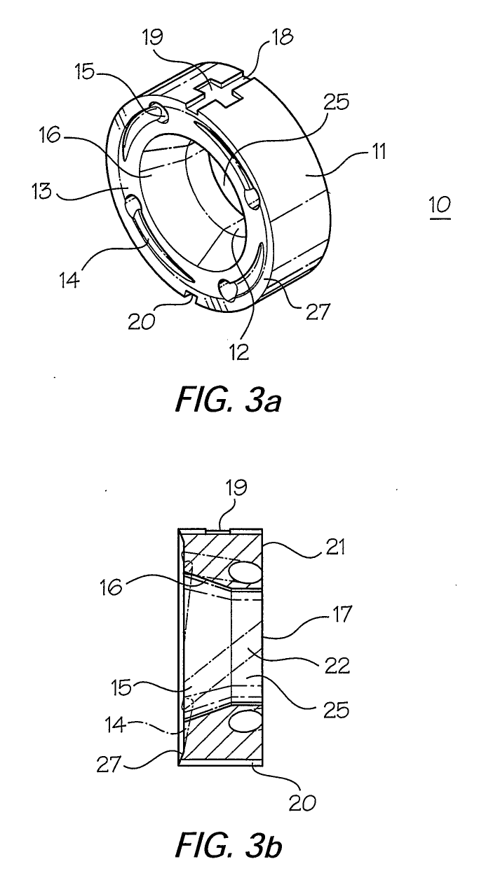

Referring to FIGS. 1, 3a and 3b, the channels (22) are bored, or otherwise formed in the throat bushing (10), so as to lead tangentially from bushing face (13) on the seal side (referred to hereinafter as seal face (13)), proximal to outer annular surface (11), through to bushing face (21) on the impeller side (referred to hereinafter as impeller face (21)), proximal to inner annular surface (12) of the throat bushing bore (25). While it is possible for the throat bushing (10) to have a single tangential channel (22), it is advantageous for two or more channels (22) to be provided in the event that one becomes blocked. Four tangential channels (22) are provided in the throat bushing (10) illustrated in FIGS. 3a and 3b.

During pump operation, the tangential channels (22) of throat bushing (10) facilitate the conversion of some of the rotating fluid flow in the seal chamber (8) into an axial flow. This axial flow is created along the outer surface of the seal chamber bore, and is driven towards the throat and away from the seal (30), as represented by arrows in FIG. 1. Particulates and other contaminants are naturally centrifuged to the outside of the seal chamber bore during operation, and the axial flow directs the particulates towards the throat bushing proximal to outer annular surface (11) thereof. The particulates are then evacuated from the seal chamber (8) through the tangential channels (22). This clearing action significantly reduces the need for flush to keep the seal chamber clear, minimizes the amount of water needed for the process, and limits the amount of effluent that must be disposed of and potentially treated. The time between repair and replacement of seal chamber components may also be extended.

The throat bushing illustrated in FIGS. 3a and 3b is particularly adapted for use with a centrifugal pump having a mechanical seal arrangement. It should be understood, however, that the present invention is not limited to this exemplary embodiment. In fact, the invention can be modified in several ways to suit the desired application and the configuration of the pump or other rotary fluid equipment.

The throat bushing shown in FIGS. 3a and 3b is defined by outer annular surface (11), inner annular surface (12) which defines the bore (25), the impeller face (21) and the seal face (13). As discussed above, the tangential channel (22) extends tangentially from the seal face (13) proximal to the outer annular surface (11), through to the impeller face (21) proximal to the inner annular surface (12). The seal face (13) defines an entrance port (15) to the tangential channel (22), with the tangential channel leading to and terminating at an exit port (17) defined by impeller face (21). The seal face (13) further defines a plurality of concave flow modifiers (14) equal in number to the number of tangential channels (22). The flow modifiers will typically begin with a small radius and taper outwards, terminating at the entrance port (15). They also typically begin at a shallow depth, and gradually increase in depth and radius until they reach the entrance port (15).

The flow modifiers (14) illustrated in FIG. 3a are formed in the seal face (13) with a directionality to match with the rotational turn of the pump shaft (3), which in this representative case is a clockwise turn, such that the flow modifiers (14) direct the rotational fluid flow imparted by the pump shaft (3) towards the entrance ports (15) and tangential channels (22). As an alternative, however, a continuous flow modifier (not shown) may be provided running at a continuous depth around the entire seal face (13), leading from one entrance port (15) to the next. The flow modifiers (14) are not essential to the operation of the throat bushing, and the device can thus be manufactured without them. However, they are advantageously included to direct the air, particulates and other contaminants towards the entrance ports (15) of the tangential channels (22). Further modifications may be made to the depth, radius, directionality and positions of the flow modifiers (14) based on the intended application.

A direction may also be given to the tangential channels (22), so as to complement the directionality of the flow modifiers (14) and turn of the pump shaft (3). For instance, the tangential channels (22) shown in FIG. 3b extend through the throat bushing (10) diagonally with respect to the axis of rotation of the pump shaft, facilitating the axial flow of particulates and contaminants out of the seal chamber (8) by complementing the rotational flow imparted by the rotation of pump shaft (3).

The outer annular surface (11) of the throat bushing (10) is designed to interface with the bore of the seal chamber (8) with a tight fit and to a specified depth. As illustrated in FIGS. 3a and 3b, outer annular surface (11) further defines a first groove, or air vent (18), at the 12 o'clock position, and a second groove, or drainage passage (20), at the 6 o'clock position, each running parallel to the axis of the pump shaft (3). Alternatively, the air vent (18) and/or drainage passage (20) may run at an angle slightly offset from the axis of the pump shaft (3). A recess may also be provided running perpendicularly through the aforementioned first groove, as a baffle (19) for the air vent (18). When the throat bushing (10) is in position within the seal chamber bore, the air vent (18) and baffle (19) will preferably be at or near the top of the seal chamber bore, with the drainage passage (20) at or near the bottom thereof.

The need for inclusion of the air vent (18) and/or drainage passage (20) will be apparent to those skilled in the art, and will depend upon the desired application of the throat bushing (10). For instance, upon start up, as the equipment fills with fluid, air may be trapped within the seal chamber and forced to the top of the bore. Up to ⅓ of the seal chamber or more can at times be filled with entrapped air. In this situation, as the pump shaft (3) begins to rotate, the air will move from the seal chamber bore to the shaft, and can envelop the seal (30) preventing any cooling action provided by the flush. To reduce heat build up and achieve greater circulation, the air vent (18) may be provided for the air to vacate the seal chamber (8). Additionally, inclusion of the drainage passage (20) is frequently advantageous to allow contaminated fluid to exit the seal chamber (8) when the pump is not in operation. This prevents process crystallization during pump downtime, and since it minimizes contaminated or caustic fluid from pooling in the bottom of the seal chamber (8), it is also a safety feature for technicians involved in pump maintenance and teardown.

If required, the throat bushing (10) may be split axially to facilitate ease of installation. In addition, as shown in FIGS. 1 to 3b, an annular clearance taper (16) may be provided around the inner annular surface (12) of the throat bushing (10), sloping inwards from the seal face (13) to a position intermediate between the seal face (13) and the impeller face (21). The taper (16) provides clearance for the shaft during installation and reduces the amount of particulate that may be trapped between the bore (25) and the pump shaft (3). With the taper (16), the particulate gravitates from the bore (25) towards the seal face (13) where it is cleared from the seal chamber (8) through the tangential channels (22).

The bore (25) of the throat bushing (10) is dimensioned to have a specified clearance from the pump shaft (3), such that the shaft (3) may pass therethrough and rotate freely.

The throat of the seal chamber will typically be machined to a specified depth so that it can receive the throat bushing (10). Accordingly, the seal face (13) may advantageously be fashioned to define a sloped annular interface (27) around the outer edge thereof, interfacing with the end of the machined bore of the throat, and serving as a stop for the throat bushing (10). The annular interface (27) thus butts against the end of the machined bore of the throat.

The throat bushing may be manufactured from any material commonly known to those skilled in the art, and generally depending upon the intended application therefor. For instance, the device may be constructed of the same material as the pump. Alternatively, it may be constructed from stainless steel, brass, bronze, titanium, ceramic materials, durable plastic materials or any other material that would withstand the forces exerted upon it during pump operation.

It is also envisioned that the device may be manufactured using a bearing material, in which case a tighter shaft clearance would be employed. In such an embodiment, the inner bore of the bushing (10) would be machined with a larger diameter to allow for a changeable inner bearing sleeve to be pressed therein. As the changeable bearing sleeve gets worn out it can be replaced with a new sleeve, thus facilitating re-use of the bushing (10).

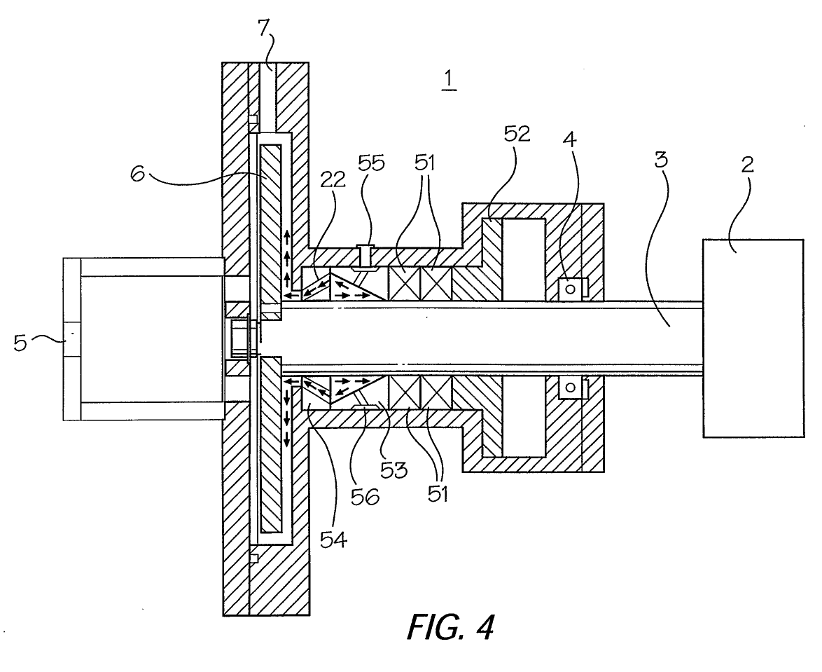

The present invention is not limited to mechanical seal applications, but can also applied to packing/stuffing arrangements as is illustrated in FIGS. 4 to 7. The invention can also be used as a bearing material for mixers and agitators (not shown), as is indicated above.

FIG. 4 illustrates a second possible operating environment for the throat bushing of the present invention, within a centrifugal pump (1) having a stuffing box arrangement. Similar to FIGS. 1 to 3b, the pump (1) shown in FIG. 4 is driven by an electric motor (2), which drives a rotary shaft (3) supported by bearings within a bearing housing (4). The shaft (3) is connected to an impeller (6) at its terminal end, and as the impeller (6) is rotated by the shaft, water or other fluid is drawn into the pump housing through an inlet (5), and pumped out to the environment through pump outlet (7).

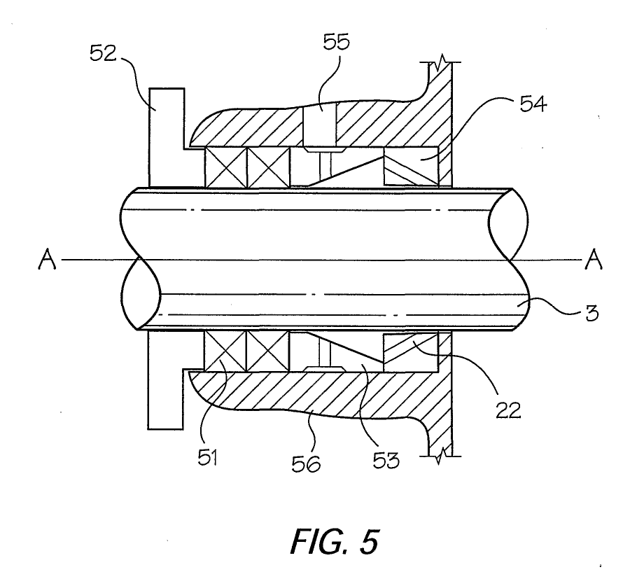

FIG. 4, and in expanded view in FIG. 5, shows a throat bushing (54) positioned in the throat of a stuffing box (56), with the pump shaft (3) running through its bore. The axis of rotation of pump shaft (3) is represented by line A-A shown in FIG. 5. As illustrated, there are two rings of stuffing (51) positioned at the rear end of the stuffing box (56), with a modified lantern ring (53) positioned between the rings of stuffing (51) and the throat bushing (54). However, there can be various numbers of packing rings employed in a typical stuffing/packing arrangement, and this number does not form part of the invention disclosed herein. In fact, depending upon thickness, there may be three or more packing rings used together with the present invention. Tangential channels (22) bored through the throat bushing (54) provide a passageway for particulate matter to be evacuated from the stuffing box (56) to the pump chamber behind the impeller (6).

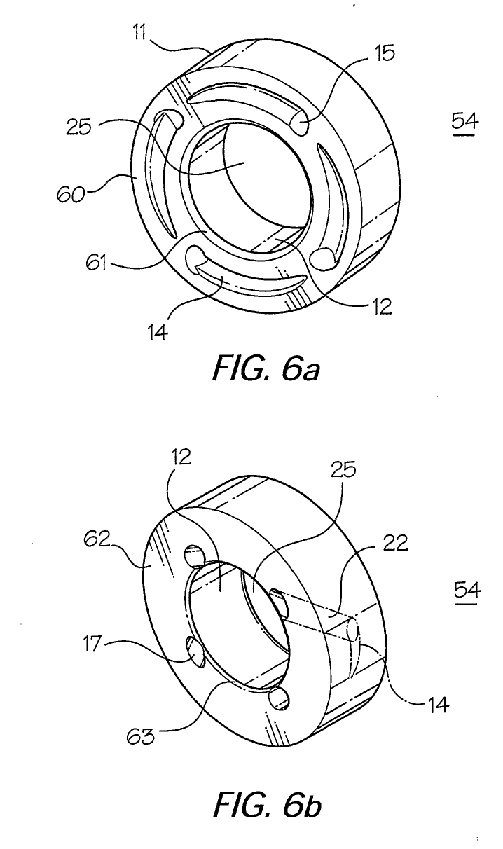

As with the above-described seal chamber example, the channels (22) shown in FIGS. 4, 5, 6a and 6b are bored, or otherwise formed in the throat bushing (54), so as to lead tangentially from bushing face (60) on the packing side (referred to hereinafter as packing face (60)), proximal to outer annular surface (11), through to bushing face (62) on the impeller side (referred to hereinafter as impeller face (62)), proximal to inner annular surface (12) of the throat bushing bore (25). As discussed above, it is advantageous for two or more channels (22) to be provided in the throat bushing (54), in the event that one becomes blocked, although it is possible for the throat bushing (54) to include only a single channel (22). Four tangential channels (22) are provided in the throat bushing (54) illustrated in FIGS. 6a and 6b.

The tangential channels (22) of throat bushing (54) operate in a similar way to those illustrated in FIGS. 1 to 3b, and facilitate the conversion of some of the rotating fluid flow in the stuffing box (56) into an axial flow. This axial flow, which is driven towards the throat and away from the packing rings (51), is described in further detail below.

The modified lantern ring (53) is provided as a preferential alternative to the lantern rings typically used in packing applications. Known lantern rings are generally H-sectioned, and are used to separate the packing rings in stuffing box arrangements. As indicated by their H-sectioned shape, they include an outer annular groove around their outer surface, which permits the injection of a fluid from a flush port, e.g., a water flush, into the stuffing box via holes drilled through the outer groove to an inner annular groove formed around the surface of the lantern ring bore. This allows access for the flush to the pump shaft and stuffing box components and facilitates cooling and lubrication thereof. As illustrated in FIGS. 4, 5 and 7, the lantern ring (53) of the present invention is similar to the known lantern ring on its outside surface, although the inside surface is modified to facilitate the axial flow of fluid and particulate matter towards the throat bushing (54) and the tangential channels (22) thereof.

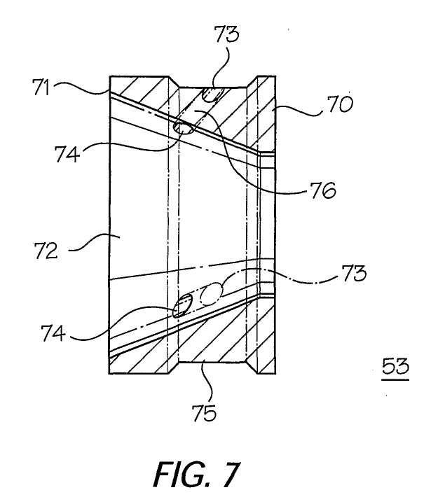

As shown in FIG. 7, lantern ring (53) defines a collection groove (75) extending annularly around the outer surface of the lantern ring. The outer surface of the lantern ring itself is dimensioned to provide a tight fit with the bore of the stuffing box (56). The bore of the lantern ring (53) is dimensioned at an end proximal to the packing rings to receive the pump shaft (3) with a close clearance, and permitting rotation therethrough. From there, the lantern ring bore tapers outwardly, starting from a position intermediate therealong, and widens in diameter towards the other end of the lantern ring (53) proximal to the throat bushing (54). The lantern ring (53) is further defined by a first face which abuts the packing rings (51), hereinafter referred to as packing face (70), and a second face which abuts the throat bushing (54), hereinafter referred to as throat bushing face (71).

Together with the pump shaft (3) and throat bushing (54), the tapered surface of the bore of lantern ring (53) defines a collection chamber (72). One or more channels (76) are also provided, leading from the collection groove (75) to the collection chamber (72). The channels (76) are defined at one end by inlet ports (73), which are spaced around the collection groove (75), and at the other end by outlet ports (74), which are spaced around the tapered surface of the lantern ring bore. Flush provided to the system by means of flush port (55) is received by the collection groove (75) and is forced into the collection chamber (72).

As with the tangential channels (22) of throat bushing (54), the channels (76) of lantern ring (53) typically lead tangentially from the inlet port (73) towards the throat bushing face (71) of lantern ring (53), terminating at the outlet port (74) within the collection chamber (72). Together with the rotational flow caused by the rotation of the pump shaft (3), and the aforementioned axial flow caused by the tangential channels (22) of the throat bushing, providing the channels (76) on a tangent in this way helps to impart an axial directionality to any flush or pumpage flowing from the outlet port (74). The axial flow within the collection chamber (72) is thus similar to that described above for the seal chamber arrangement, and as illustrated by arrows in FIG. 4, moves along the tapered surface of the bore of lantern ring (53) towards the throat bushing (54), carrying any particulate matter out of the stuffing box (56) via the tangential channels (22) in the throat bushing (54).

A direction may also be given to the channels (76) of lantern ring (53) so as to correspond with the turn of the pump shaft (3). For instance, the channels (76) shown in FIG. 7 extend through the lantern ring (53) diagonally with respect to the axis of rotation of the pump shaft, allowing the inflow of flush or pumpage from the collection groove to complement the directionality of the rotational flow within the collection chamber (72), the directionality being imparted by the rotation of pump shaft (3).

Throat bushing (54) is particularly adapted for mating with the throat bushing face (71) of lantern ring (53). As illustrated in FIGS. 6a and 6b, throat bushing (54) is defined by outer annular surface (11), inner annular surface (12) which defines the bore (25), the impeller face (62) and the packing face (60). The tangential channel (22) extends tangentially from the packing face (60) proximal to the outer annular surface (11), through to the impeller face (62) proximal to the inner annular surface (12). The packing face (60) defines entrance ports (15) to the tangential channels (22), with the tangential channels leading to and terminating at exit ports (17) defined by impeller face (62). The packing face (60) further defines a plurality of concave flow modifiers (14) equal in number to the number of tangential channels (22). The flow modifiers are identical to those illustrated in FIG. 3a and as discussed above. A continuous flow modifier (not shown) similar to that described above may also be used as an alternative to the plurality of flow modifiers (14).

As discussed above for the throat bushing (10) adapted for the seal chamber arrangement, a direction may also be given to the tangential channels (22), so as to complement the directionality of the flow modifiers (14) and turn of the pump shaft (3). In the present example shown in FIG. 6b, the tangential channels (22) extend through the throat bushing (54) diagonally with respect to the axis of rotation of the pump shaft, facilitating the axial flow of particulates and contaminants out of the stuffing box (56) by complementing the rotational flow imparted by the rotation of pump shaft (3).

The outer annular surface (11) of the throat bushing (54) is designed to interface with the bore of the stuffing box (56) with a sliding fit which generally allows the bushing to be slid down the pump shaft into the bottom of the stuffing box during installation. The bore (25) of the throat bushing (54), on the other hand, is dimensioned to receive the pump shaft (3) with a specified clearance and enabling free rotation of the shaft (3) therein.

Optionally, an annular clearance relief (61), or chamfer, may be cut around the edge of the throat bushing (54) at the interface between the inner annular surface (12) and the packing face (60). The annular clearance relief (61) reduces the amount of particulate that may be trapped between the bore (25) and the pump shaft (3) by allowing the particulate to gravitate from the bore-shaft interface towards the packing face (60), where it is cleared from the stuffing box (56) through the tangential channels (22).

A second optional chamfer (63) may also be cut around the edge of the throat bushing (54) at the interface between the inner annular surface (12) and the impeller side face (62). This chamfer (63) is provided to facilitate positioning of the exit ports (17) as close to the throat bushing bore (25) as possible. As illustrated in FIG. 6b, the exit ports (17) empty out, at least partially, into the chamfer (63), closely proximal to the bore-shaft interface at the impeller side face (62) of throat bushing (54).

As shown in FIGS. 4 and 5, the throat bushing (54) and lantern ring (53) are positioned together in the stuffing box (56) with the mating faces adjacent to each other, ie., packing side face (60) of throat bushing (54) and throat bushing face (71) of lantern ring (53). The dimensions of the throat bushing face (71) will therefore accommodate the elements of the packing side face (60) of throat bushing (54). In particular, the entrance ports (15) and flow modifiers (14) will preferably be positioned on the packing side face (60) of throat bushing (54) as close as possible to the outer annular surface (11) thereof without being obstructed by the lantern ring (53).

Rings of packing (51) will typically be positioned behind the lantern ring (53), and secured within the stuffing box (56) by gland follower (52). As illustrated there are two rings of packing (51), although this number may vary. This arrangement is typical to most centrifugal pump stuffing boxes, although alternate arrangements may also be envisioned.

The throat bushing (54) and lantern ring (53) are described above and in FIGS. 4 to 7 as separate unitary mating pieces, in order to facilitate installation thereof. If required, however, each piece may be split axially into two pieces to further facilitate the installation process. Alternatively, it is further envisioned that the throat bushing (54) and lantern ring (53) could be manufactured as one single unitary device.

It will be appreciated that many modifications may be made without departing from the spirit and scope of this invention as defined by the appended claims.

### INDUSTRIAL APPLICABILITY

The invention described herein provides a throat bushing that reduces the amount of flush required in pumping applications involving fluid-dispersed particulates, or slurries. The throat bushing is also an effective means of reducing the amount of air and particulate matter that becomes trapped in the pump seal chamber or stuffing box during operation of centrifugal pumps and other such rotary fluid equipment. Use of the invention as described herein may also be effective in reducing downtime caused by equipment failure, and associated maintenance and repair costs.

1. A throat bushing (10, 54) for use in a seal chamber (8) or stuffing box (56) of rotary fluid equipment, said throat bushing defining a first face (13, 60) and a second face (21, 62), an outer surface (11) dimensioned to be received with a tight fit within a throat or bore of said seal chamber (8) or stuffing box (56), and a bore (25) therethrough dimensioned to receive a rotary shaft (3) with clearance to permit free rotation of said rotary shaft (3) therein, characterized in that said throat bushing comprises at least one tangential channel (22) therethrough, said tangential channel (22) leading tangentially from the first face (13, 60) proximal to the outer surface (11), through to the second face (21, 62), proximal to an inner annular surface (12) of the throat bushing bore (25).

2. The throat bushing according to claim 1, characterized in that said tangential channel (22) is defined at said first face (13, 60) by an entrance port (15) and at said second face (21, 62) by an exit port (17).

3. The throat bushing according to claim 2, characterized in that said first face (13, 60) defines at least one concave flow modifier (14) extending annularly at a predetermined radius from the bore (25), leading to and terminating at said entrance port (15).

4. The throat bushing according to claim 3, characterized by a plurality of said tangential channels (22) and flow modifiers (14), said flow modifiers (14) being equal in number to the number of tangential channels (22) and having a starting point intermediate between adjacent entrance ports (15), said flow modifiers (14) tapering outwards in width and depth from the starting point and terminating at the respective entrance port (15) at a width substantially equivalent to a diameter of said entrance port (15).

5. The throat bushing according to claim 3, characterized by a plurality of said tangential channels (22) and flow modifiers (14), said flow modifiers (14) extending continuously between adjacent entrance ports (15) at a width substantially equivalent to a diameter of said entrance ports (15).

6. The throat bushing according to claim 1, characterized in that said tangential channel (22) leads tangentially from the first face (13, 60) proximal to the outer surface (11), through to the second face (21, 62), proximal to the inner annular surface (12), left or right of a rotational axis of said rotary shaft (3) to match a rotational turn of said rotary shaft (3).

7. The throat bushing according to claim 1, characterized in that said tangential channel (22) leads tangentially from the first face (13, 60) proximal to the outer surface (11), through to the second face (21, 62), proximal to the inner annular surface (12), linearly along a rotational axis of said rotary shaft (3).

8. The throat bushing according to claim 1, characterized in that said outer surface (11) comprises a first groove (18) extending from the first face (13, 60) through to the second face (21, 62).

9. The throat bushing according to claim 8, characterized in that said outer surface (11) comprises a second groove (20) extending from the first face (13, 60) through to the second face (21, 62), said first groove (18) and second groove (20) being positioned opposite each other on the outer surface (11).

10. The throat bushing according to claim 8, characterized in that said outer surface (11) comprises a recess or notch (19) across the first groove (18) and extending perpendicularly thereto.

11. The throat bushing according to claim 1, characterized in that said inner annular surface (12) of said bore (25) comprises a clearance taper (16), said clearance taper (16) starting within the bore (25) intermediate between the first face (13) and second face (21), and tapering annularly outwards towards said first face (13).

12. The throat bushing according to claim 1, characterized in that said first face (13) defines an annular sloped interface (27) which splays outwards from the first face (13) around the outer circumference thereof.

13. The throat bushing according to claim 1, characterized in that said inner annular surface (12) of said bore (25) comprises a first annular chamfer (61) around the interface between the inner annular surface (12) and the first face (60).

14. The throat bushing according to claim 1, characterized in that said inner annular surface (12) of said bore (25) comprises a second annular chamfer (63) around the interface between the inner annular surface (12) and the second face (62).

15. A lantern ring (53) for use in a stuffing box (56) of rotary fluid equipment, said lantern ring defining a first face (70) and a second face (71), an outer surface dimensioned to be received with a tight fit within the stuffing box (56), a collection groove (75) formed annularly around said outer surface for receiving fluid from a source, and a bore therethrough dimensioned to receive a rotary shaft (3) with clearance to permit free rotation of said rotary shaft (3) therein, characterized in that:
said bore tapers outwardly towards the second face (71) starting from a position intermediate between the first face (70) and the second face (71); and
said lantern ring (53) comprises at least one channel (76) leading from an inlet port (73) on the collection groove (75), to an outlet port (74) on the tapered surface of the lantern ring bore, said channel (76) leading tangentially from the inlet port (73) towards the lantern ring second face (71).

16. The lantern ring according to claim 15, characterized in that said channel (76) leads tangentially from the inlet port (73) on the collection groove (75) to the outlet port (74) on the tapered surface of the lantern ring bore, left or right of a rotational axis of said rotary shaft (3) to match a rotational turn of said rotary shaft (3).

17. The lantern ring according to claim 15, characterized in that said channel (76) leads tangentially from the inlet port (73) on the collection groove (75) to the outlet port (74) on the tapered surface of the lantern ring bore, linearly along a rotational axis of said rotary shaft (3).

18. The lantern ring according to claim 15, characterized in that said lantern ring (53) comprises a plurality of channels (76), each leading from an inlet port (73) on the collection groove (75), to an outlet port (74) on the tapered surface of the lantern ring bore.

19. (canceled)

20. A kit comprising the lantern ring (53) defined in claim 15 and the throat bushing (54) defined in claim 1.

21. A device for replacing a lantern ring and one or more rings of packing in a stuffing box (56) of rotary fluid equipment, characterized by comprising as a single unitary element:
the lantern ring (53) defined in claim 15; and
the throat bushing (54) defined in claim 1,
wherein the second face (71) of the lantern ring (53) is connected to the first face (60) of the throat bushing (54), and said entrance ports (15) and flow modifiers (14) of the throat bushing (54) are positioned on the first face (60) of throat bushing (54) as close as possible to the outer surface (11) thereof without being obstructed by the lantern ring second face (71).
